(19) United States
(12) Patent Application Publication
(10) Pub. No.: US 2020/0039243 A1
(43) Pub. Date: Feb. 6, 2020

(54) Printing on the Inside walls of disposable drinking cups

(71) Applicant: William Joseph Riffe, Beaufort, NC (US)

(72) Inventor: William Joseph Riffe, Beaufort, NC (US)

(21) Appl. No.: 15/998,310

(22) Filed: Aug. 6, 2018

(51) Int. Cl. B41J 3/407; G09F 23/00

(52) U.S. Cl. CPC B41J 3/4073; G09F 23/00

(57) ABSTRACT

A system of information, printed upon the interior walls of a disposable plastic cup, that instructs an observer as to the amount of liquid or dry contents, held by said cup and how to affix said information to cup.

### BACKGROUND OF THE INVENTION

### 1. Field of the Invention

The present invention relates generally to a common type of container, manufactured in unimaginable quantities and designed for disposal after completion of limited usage. This vast production is mainly composed of numerous sorts of drinking cups into which differing amounts of materials are introduced in order to create a great variety of desired combinations.

### 2. Discussion of the Background Art

Over a century ago it was discovered that paper, which was only just coming into common use, could be folded in a certain manner which created a satisfactory, if temporary, container. Chief among these, of course, were sacks and other types of containers for dry materials. Shortly it was discovered that a certain fold on a mere scrap of paper could be made to also transport small amounts of liquids. Among the liquids so transported turned out to be water. It evolved that the water was often potable and so was born the liquid containing drinking cup. That was over one hundred years ago; and the simple, folded paper drinking cup has undergone a multitude of alterations. This has been amplified by the advent of economical and moldable plastics which have widened the field for vessels of temporary usage beyond all prediction.

This discussion does not include other kinds of cups made of stone, pottery, glass, coconuts or other types of wood and especially metals. Metals and glass have, over the years, been a source for numerous vessels termed “measuring cups” simply because they are marked in various manners to provide relatively accurate measurements of limited volumes of flowable materials such as liquids and ground or crushed solids. In the main such containers have not filled much of the role of drinking cups or “glasses.” In many past societies drinking cups were so prized as to have often been reserved to one person only. Today it is nearly the obverse!

Now the world society, by a vast majority, drinks mainly from some sort of disposable cup! A cursory inspection of any landfill quickly substantiates the fact. And the various liquids consumed from such cups is extreme in numbers of names if not as much in different contents. In a large number of cases the materials to be contained call for differing quantities to be mixed prior to consumption. Quite often it will be seen that individuals are using various measuring devices in order to correctly follow the directions on how to blend the ingredients called for in the disposable drinking cup. This is the case millions of times a day when people are preparing tea, soup, Ovelteen, Kool Aid, numerous other products and especially instant coffee with “just enough” cream! The work force of the planet is accustomed to making these required measurements every day. And, often, the measurements are applied incorrectly within the cups in which they are mixed! This inadvertent mistake immediately results in user dissatisfaction or at least disappointment!

### SUMMARY AND OBJECT OF THE INVENTION

Accordingly, one object of the invention is to mark the interior of disposable drinking cups so that the various levels of volumes contained within the individual drinking cup are readily observable in order to measure the content within the drinking cup at any time.

Another object of the present invention is to include or substitute other data or pertinent printed messages of social or commercial value within the interior of disposable plastic drinking cups.

Another object of the present drinking cup invention is to provide any and all markings within the drinking cup in a nonpoisonous and permanent manner. Such can be done with nontoxic coatings and inks or may be molded into the drinking cup wall proper!

Yet still another object of the present drinking cup invention is to prevent the interior markings from unintentionally showing through any thin or translucent walls of the drinking cups.

### BRIEF DESCRIPTION OF FIGURES

FIG. 1 is a perspective view of printing as on the inside walls of a transparent drinking cup to illustrate the markings and lines of the quantifiable volumes within the cup which would not be externally visible on foamed disposable drinking cups.

FIG. 2 is a perspective view of a wide rubber brayer used to press the paper in a letter press against the inked type and of a narrow roller printer with a self inking reservoir.

FIG. 3 is a diagrammatic perspective of a cup printing station where freshly molded cups are transported in female sockets to beneath a set of expandable, collet type heads, that print data on the interior walls of the cup.

FIG. 4 is a breakdown of how a rubber sleeve, with laser cut type, fits on an expandable printing head that is then moved into the plastic cup, and is expanded to contact and print on the walls of the cup.

### REFERENCE NUMERALS OF THE FIGURES

1. Dry measure lines and identities.
2. Wet measure meniscus lines and identities.
3. Frame and handle of large brayer pressing roller.
4. Small hand held inking roller.
5. Rubber brayer type roller.
6. Ink self application wheel on small print roller.
7. Small print roller wheel.
8. Fresh, unprinted plastic cups.
9. Printed plastic cups moving on production line.
10. Socket ready to receive cup for printing.
11. Cup ready to enter socket for printing.
12. Pneumatic cylinder to inflate collet.
13. Rubber printing sleeve entering cup.
14. Cup within socket receiving printing collet.
15. Pneumatically expandable printing collet.

### DETAILED DESCRIPTION OF THE PREFERRED EMBODIMENT

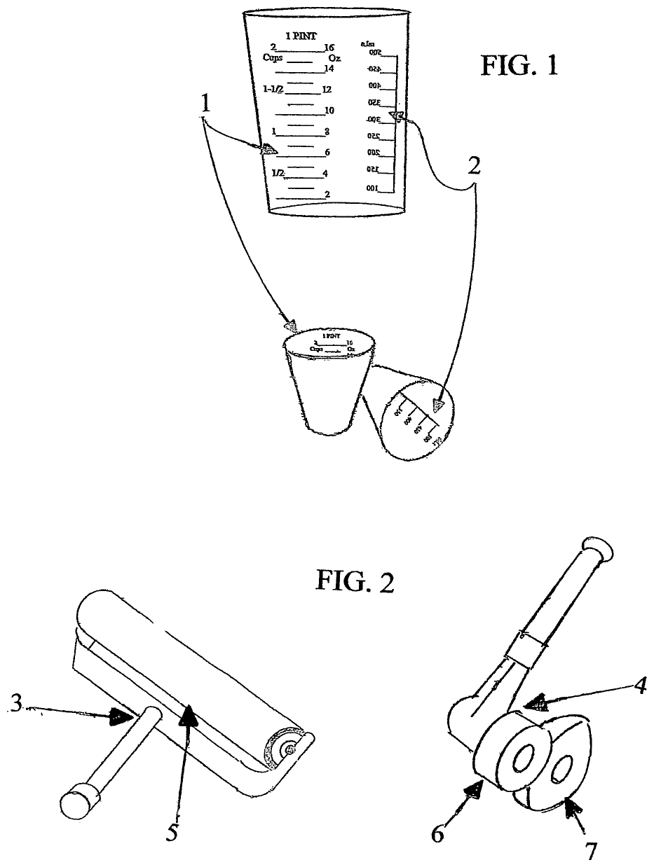

There are several systems of marking on the insides of disposable drinking cups. One way is to inscribe the desired information upon the drinking cup male or female mold form. It can be done in very small type upon the form that will disturb the molding process in no way. Such is often done upon the bottom of molded cups by manufacturers wishing to identify with their product! This method leaves the intended information embossed upon the bottom of the molded plastic cup. There is a lack of visibility of were their carefully measured capacities to be clearly printed as partially circumscribed lines upon the interior walls of the cups. FIG. 1 The volumes for particular cups to be identified alongside the lines would be useful both in cooking and recreational drinking. There would be lines marking dry volumes on one side of the cup (1) and equivalent markings for wet capacity on the opposite side. (2) The most numerous materials for such marking purposes are inks.

Printing inks consist of three parts: vehicle, pigment and binder. These are formulated within oil based, rubber based or acrylic inks. Each type is selected upon the basis of the surface and material to be printed. In all cases there is a requirement for the use of nontoxic materials through out! It is likely that in all situations too there will be a case for the use of a surface sealer before any printing is attempted. Industry has had ample experience in the use of very simplistic devices for surface printing of both private and government codes upon its containers for eons. Much of which application was done with hand held small roller applicators. FIG. 2 It would require very little engineering to mechanize the operation of small, 3,4 roller 5,7 printers for use on a drinking cup production line.lightly embossed lines on uncolored plastics. On paper cups the paper stock is simply preprinted! In the case of disposable plastic drinking cups it would improve their utility

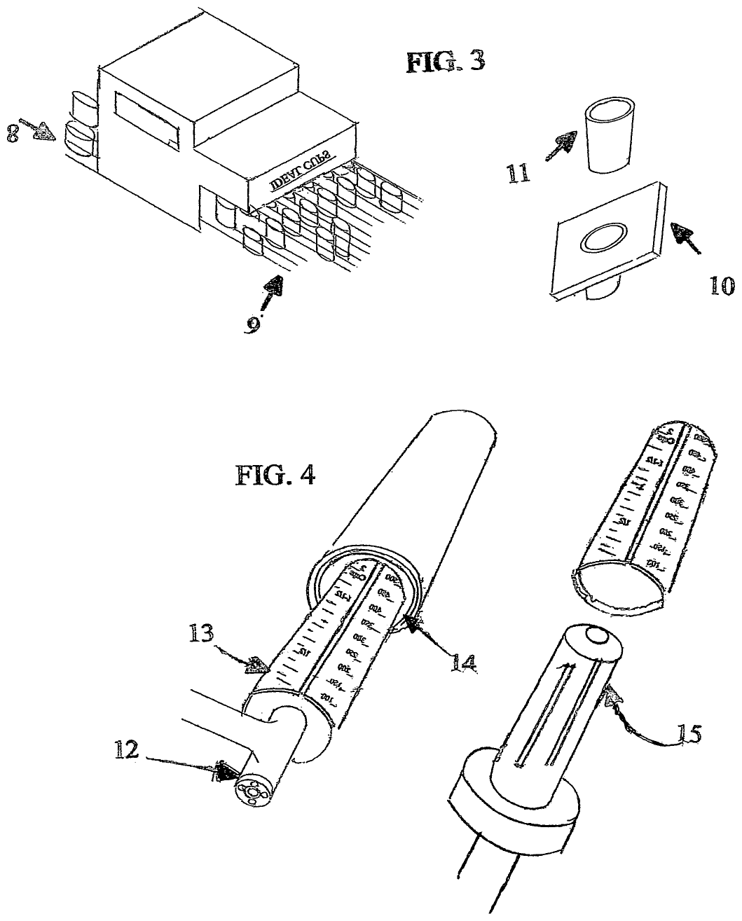

In production of the disposable drinking cups the major component is moldable plastic. The form for the drinking cups is a plug and socket FIG. 3 with the plastic shape for each cup 11 molded in between. When a molding cycle is complete the mold opens and the finished cups slide off the plug or out of the socket into a valley adjacent the mold where they are aligned and transported by air and vibration 9 along the production line for sorting and packaging. This point is where the printing will occur. Beside the moving line of disposable drinking cups there will be a series of female sockets 10 shaped like the drinking cups into which said disposable drinking cups are sucked by a gentile air breeze and low vacuum such as to do no damage to the recently molded drinking cups.

As a socket is filled with a fresh, disposable drinking FIG. 4 cup a sensor will activate the printing machine and a printer head will advance through the open mouth of the drinking cup 14 to the printing position within the drinking cup. The present state of the art makes using a typical electronic printing head within the confines of various disposable drinking cups extremely difficult. Therefore a modified, mechanical form of letterpress printing will be used instead. Once inside the drinking cup, the collet like printing head 15 will expand and force the print sleeve 13 to contact the interior walls of the drinking cup. 14 The sleeve type will be pressed upon the walls of the newly formed disposable drinking cup. By printing with a modified letterpress system the mechanics of causing either one or both of the cup and printer head to roll counter to one another are eliminated. That simplifies the production process! Upon completion of printing, the head contracts and will be withdrawn from the interior of the drinking cup and retracted to its resting position. There it will receive a fresh coating of ink to be used in the next printing cycle. All the directional movements of the printing head will be occasioned by sensor controlled stepping motors and small pneumatic cylinders instructed from a dedicated computer supervising the entire drinking cup production process.

After completion of a printing pass the freshly molded and printed drinking cups continues on along the production line for packaging and distribution. Printing will consume no more time than the molding process. In the case of the ordinary disposable drinking cup the data printed upon the inside will be quite visible through the mouth of the disposable drinking cup from outside the cup! It should even be partially visible while drinking from the cup. The amount of printed content is a decision to be made by the company producing the drinking cups. Too many lines and it would be difficult to discern the lines from the fluid meniscus inside the drinking cup. The color of the printing inks used should be based upon ergonomic testing to determine which is the best for all around use of the drinking cups. Or, a customer might be provided a group of colors from which to choose for special occasions. zThis extremely simple printing system makes changing ink colors during a production run very simple!

What is claimed as novel and desired to be secured by Letters Patent of the United States is:

1. A system comprising: (a) increased utility of disposable plastic drinking cups provided by printing, upon their interior walls, of semi circumferential lines identified by matching printed units of measure, designating the volumes contained at various liquid meniscus or dry product levels marked by said lines within disposable plastic drinking cups; and (b) for promotional or advertising purposes, logos or other organizational identification markings will be imprinted within disposable plastic drinking cups as either stand alone views or included with more complex art work; and (c) further comprises means for modifying, or designing, electronic, mechanical or other forms of print heads, for impression of printed data upon the interior walls of disposable plastic drinking cups.

2. The method of claim 1. wherein any fillers, coatings and inks employed to print lines and units of measure upon the interior walls of disposable plastic drinking cups are nonreactive with the chemical makeup of said cups, permanent and insoluble in water and other potable liquids and nontoxic for humans and associated animals.

3. The method of claim 2. wherein the printing upon the interior surfaces of the walls of said cups will not bleed through to the outside wall surfaces under hot or cold conditions or be visible upon the exterior surface of the disposable plastic drinking cup walls.

4. The method of claim 2. wherein printing ink used within the interior of the disposable plastic drinking cups will not cause deformation of the cup at any point by conduction of heat through the ink causing localized softening of the plastic walls of the cup.

5. The method of claim 4. comprising means for preventing weakening of disposable plastic drinking cup walls resulting from thinning of said walls by repeated scraping, upon raised areas of printing ink, while contents of a cup are being stirred and mixed.

6. The system of claim 5. comprising means for control of printing ink application that will prevent any thickening or buildup of excess ink while either printing, or from incidental spillage during printing, upon the interior walls of the disposable plastic drinking cups.
